(19) United States
(12) Patent Application Publication
(10) Pub. No.: US 2012/0066617 A1
(43) Pub. Date: Mar. 15, 2012

(54) SYSTEMS AND METHODS FOR CONTROLLER PILOT DATA LINK COMMUNICATION (CPDLC) MESSAGE PROCESSING USING DYNAMIC ON-DEMAND SCREEN GENERATION FOR MESSAGE RESPONSE AND COMPOSITION

(75) Inventors: Reetu Gupta, Redmond, WA (US); Thomas F. McGuffin, Bellevue, WA (US)

(73) Assignee: HONEYWELL INTERNATIONAL INC., Morristown, NJ (US)

(21) Appl. No.: 12/882,258

(22) Filed: Sep. 15, 2010

(51) Int. Cl. G06F 3/048

(52) U.S. Cl. 715/752

(57) ABSTRACT

Systems and methods for CPDLC message processing using dynamic on-demand screen generation for message response and composition are provided. In one embodiment, a method for processing received CPDLC messages comprises: receiving a CPDLC message having a plurality of message elements; extracting the plurality of message elements from the CPDLC message; generating a first display screen at a user display interface for a first extracted message element, wherein the first display screen includes a user response field corresponding to a message-type attribute associated with the first extracted message element; generating a second display screen at the user display interface for a second extracted message element, wherein the second display screen includes a user response field corresponding to a message-type attribute associated with the second extracted message element; composing a response CPDLC message from a first user responses received via the first and second display screens; and sending the response CPDLC message.

### GOVERNMENT RIGHTS

The U.S. Government may have certain rights in the present invention as provided for by terms of Government Contract No. DTFAWA-10-A-80003 with the U.S. Federal Aviation Administration.

### BACKGROUND

Flight crew personnel and air traffic controllers communicate with each other through uplink and downlink messages. The ground-based and on-aircraft systems that support composing and accessing of these communications undergo an exacting design process followed by extensive testing, verification and validation, and agency certification, before they can be released for production and installed in aircraft and ground control facilities. Currently, the design of the human machine interface (HMI) used by pilots to receive uplink messages and initiate downlink messages is very static. The designers of the HMI need to predict what combinations of messages and data requests will be exchanged between a pilot and air traffic controllers and design HMI display screens that are appropriate for those combinations. That is, for each anticipated combination of message elements an uplink (or downlink) message comprises, a dedicated screen for that combination is designed and programmed into the HMI. Once released into production, if an end user requires a combination of message elements not anticipated by the HMI designer, a new HMI display screen for that new combination must be designed and incorporated into the HMI, and the extensive testing, and verification and validation, and agency certification must be repeated. Further, new communication standards, such as “FAA NextGen” proposed by the United States Federal Aviation Administration (FAA), will include more than 400 different message elements that can be included in an uplink or downlink message.

For the reasons stated above and for other reasons stated below which will become apparent to those skilled in the art upon reading and understanding the specification, there is a need in the art for improved systems and methods Controller Pilot Data Link Communication (CPDLC) Message Processing.

### SUMMARY

The Embodiments of the present invention provide methods and systems for CPDLC message processing using dynamic on-demand screen generation for message response and composition and will be understood by reading and studying the following specification.

In one embodiment, a method for processing received CPDLC messages comprises: receiving a CPDLC message having a plurality of message elements; extracting the plurality of message elements from the CPDLC message; generating a first display screen at a user display interface for a first extracted message element, wherein the first display screen includes a user response field corresponding to a message-type attribute associated with the first extracted message element; generating a second display screen at the user display interface for a second extracted message element, wherein the second display screen includes a user response field corresponding to a message-type attribute associated with the second extracted message element; composing a response CPDLC message from a first user responses received via the first and second display screens; and sending the response CPDLC message.

### DRAWINGS

Embodiments of the present invention can be more easily understood and further advantages and uses thereof more readily apparent, when considered in view of the description of the preferred embodiments and the following figures in which:

FIGS. 1A and 1B are block diagram illustration of a CPDLC communication system 100 of one embodiment of the present invention;

FIG. 2 illustrate an HMI display for one embodiment of the present invention;

FIG. 3 illustrates an HMI display for one embodiment of the present invention;

FIG. 4 is a flow chart illustrating CPDLC message processing for one embodiment of the present invention;

FIG. 5 is a flow chart illustrating CPDLC message processing for one embodiment of the present invention; and

FIG. 6 is a flow chart illustrating CPDLC message processing for one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Controller Pilot Data Link Communication (CPDLC) is a data dictionary based communication system. Messages are composed from predefine message elements and data elements. In CPDLC, a message may contain from 1 to 5 message elements. Simple messages consist of one message element such as WILCO or CLIMB TO 37,000 FEET. Message elements have attributes such as priority, alert level and response type. The response type defines the message elements that should be used to compose the response message. CPDLC has defined the response types Wilco/Unable, Affirm/Negative, Roger, Yes and None. The response for a message with response type Wilco/Unable is Wilco or Unable. The response for a message with response type Affirm/Negative is Affirm or Negative. The response for a message with response type Roger is Roger or Unable. The response message element for a message with response type Yes is unique for each message element with that response type. For example, a valid response for REPORT PRESENT ALTITUDE is PRESENT ALTITUDE 37,000 Feet, which requires more effort from the crew than pressing an WILCO or UNABLE button. CPDLC requires that the responses for all message elements in a message be contained the corresponding CPDLC response message.

Embodiments of the present invention provide systems and methods for CPDLC communication with sufficient flexibility to allow messages containing any combination of message elements, without the need to anticipate and pre-define HMI display screens for each possible combination.

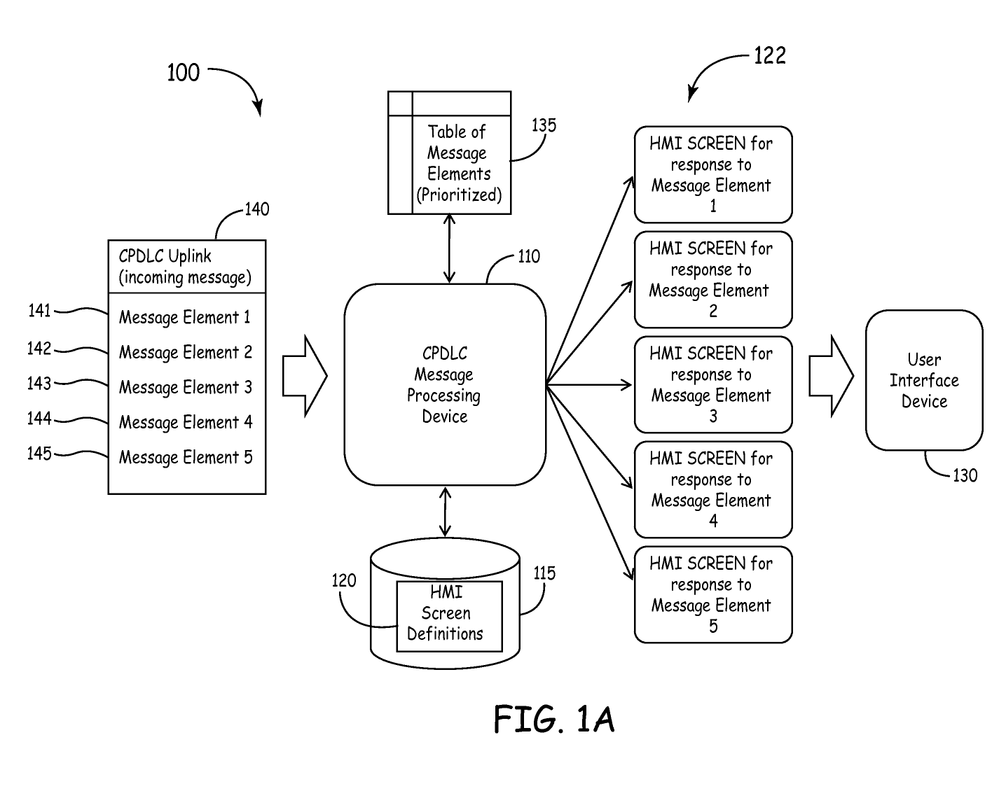

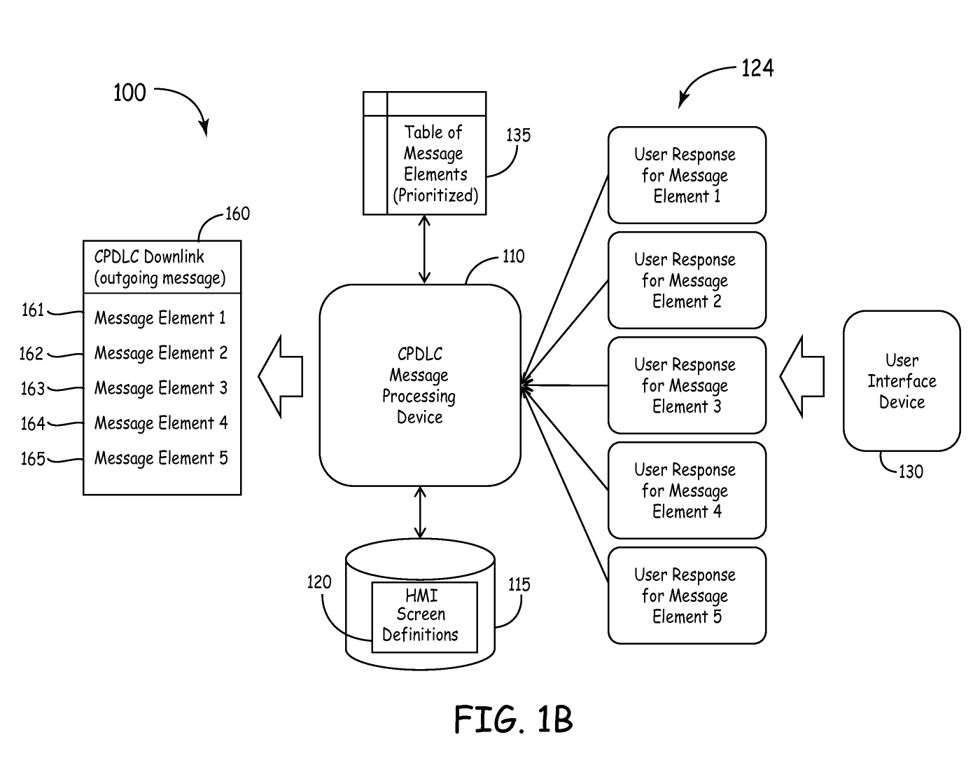

FIG. 1A is a block diagram illustrating a CPDLC communication system 100 of one embodiment of the present invention. CPDLC communication system 100 comprises a CPDLC Message Processing Device 110 having access to at least one storage device 115 that includes HMI Screen Definitions 120.

In one embodiment, the CPDLC communication system 100 is installed on the same on-board aircraft system where the aircraft's CPDLC applications are installed. For example, in some embodiments, the physical device performing as the CPDLC Message Processing Device 110 will be an aircraft's Communication Management Unit (CMU or CMF) or Flight Management Computer (FMC or FMF), or other system executing the CPDLC application. In some embodiments, therefore, functions of the CPDLC Message Processing Device 110 discussed herein are implemented at least in part as a software application executing on such physical devices. As shown in FIG. 1A, the CPDLC communication system 100 is coupled to at least one user interface device 130. In alternate embodiments, the user interface device 130 may comprise a touch screen display interface, or a MCDU unit having a display with programmable buttons (for example, Line Select Keys (LSK)) or other interface mechanisms. The HMI Screen Definitions 120 includes screen definitions that include at least one HMI display screen display for each possible message element that may be received in CPDLC message so that message elements can be displayed, and responses generated, via user interface device 130.

In operation, CPDLC Message Processing Device 110 receives an CPDLC uplink 140 comprising up to 5 individual message elements (shown as 141-145). For each message element, CPDLC Message Processing Device 110 extracts a message element ID and generates a series of HMI display screens for displaying their corresponding message and prompting a valid response. Optionally, extracted message elements ID(s) can be used to populate a table 135 that includes information and attributes such as, but not limited to the priority, alert level and response type for each element.

In one embodiment, CPDLC Message Processing Device 110 displays messages to a user, and prompts for valid responses, by stepping the user through a series of HMI display screens (shown generally at 122). For example, when a flight crew member decides to respond to a CPDLC uplink 140, CPDLC Message Processing Device 110 utilizes extracted elements IDs to call bring up specific HMI display screens 122 onto user interface device 130. Those specific HMI display screens 122 are presented to the flight crew user, one at a time, via user interface device 130. In one embodiment, CPDLC Message Processing Device 110 presents HMI display screens 122 to the flight crew user (e.g., the pilot) in the same order as their corresponding message elements appear in the CPDLC uplink 140. This order can be preserved by table 135. In another embodiment, CPDLC Message Processing Device 110 displays HMI display screens 122 to the user in an order based on a priority attribute associated with each message element. In that case, CPDLC Message Processing Device 110 displays the HMI display screen 122 for the highest priority message element first, then the HMI display screen 122 for the next highest priority message is displayed, and so on.

As an example, in one embodiment, CPDLC Message Processing Device 110 receives a CPDLC message 140 that contains multiple message elements. A separate HMI display screen 122 is displayed on use interface device 130 for composing a response to each message element. For example, if the uplink message 140 contains the message elements “REPORT PRESENT ALTITUDE” and “REPORT PRESENT SPEED” then when the user elects to response to the uplink message 140, the HMI display screen 122 for the “REPORT PRESENT ALTITUDE” message element and a field for composing the response to that message element is displayed on user display device 130. The user enters the present altitude data, then verifies the data then accepts it. In one embodiment, on-board computers automatically supply the information requested information into the response field and the use need only very that it is correct. The CPDLC Message Processing Device 110 then proceeds to the next message element, in this example REPORT PRESENT SPEED, and the HMI display screen for composing the response to that message element is displayed. The user enters the data if it's not all ready present, verifies the data and then accepts it. When the flight crew user responds to the final HMI display screen, he is provided the option to submit, and CPDLC Message Processing Device 110 composes a downlink CPDLC message that includes the responses for each uplink message element. In one embodiment, the user is provided an opportunity to review and approve the complete downlink CDLC message before it is transmitted.

As another example, a CPDLC message may alternately include a mixture of response types. For example, uplink message 140 may include message elements “CLIMB TO FL345” and “REPORT PRESENT SPEED”. When the user elects to response to the uplink message, the HMI display screen 122 for the “CLIMB TO FL345” message element and a field for composing the response to that message element is displayed on user interface device 130. In this case, the message type for this element is WILCO/UNABLE. Therefore, the HMI display screen presents the user with two choices for composing a response: WILCO and UNABLE. When the user selects one, he is advanced to the next HMI display screen 122 to respond to the REPORT PRESENT SPEED element. When the flight crew user responds to the final HMI display screen, he is provided the option to submit, and CPDLC Message Processing Device 110 creates the downlink CPDLC message that includes the responses for each uplink message element. A complete downlink message response for this example would be “WILCO, PRESENT SPEED M0.912”, for example. As mentioned above, the user can be provided an opportunity to review and approve the complete downlink CDLC message before it is transmitted.

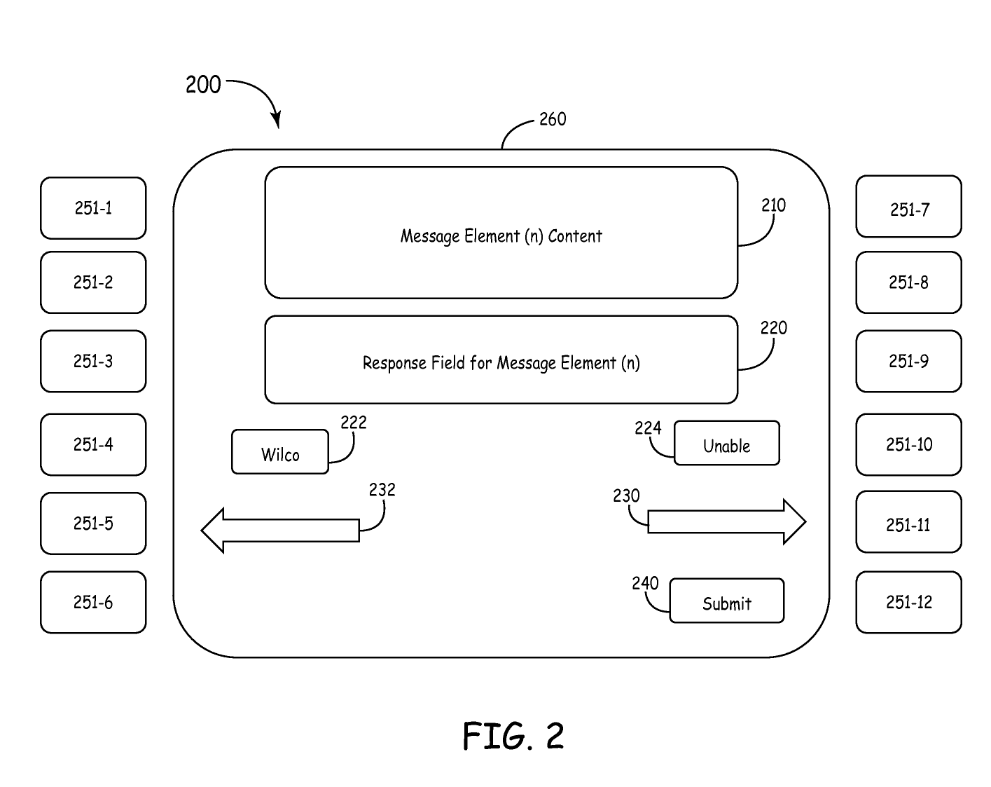

FIG. 2 illustrates one embodiment of an HMI display screen 200 for building a response to a multiple element CPDLC message, by displaying message element HMI display screens 122 in a series manner as just described above. For this illustration, HMI display screen 200 is defined based on the attributes associated with a message element (n) having its message element ID extracted from a CPDLC message. HMI display screen 200 includes a first field 210 for displaying the message element content for that message element (n), and a second field 220 for entering a response to the message element content. For example, when the message element (n) content displayed in the first field 210 requires a “Wilco/Unable” response, the second field 220 will display a button 222 for entering a “Wilco” response, and a button 224 for entering an “Unable” response. When the message element (n) is of type “Yes”, the second field 220 instead displays an area to enter data. That is, when message element (n) is a request for the flight crew to enter its current altitude, the second field 220 will provide an entry field to enter current altitude data. In one embodiment, second field 220 will automatically include the data requested by the message element (n) (e.g., retrieved from the flight control computer or other on-board data resource) and fill in the second field 220 with that data. In that case, the flight crew user need only verify the data rather than enter it. A message advancement button 230 (shown as “Next”) permits the flight crew user to advance to the HMI display screen for the next message element to be displayed. In one embodiment, when HMI display screen 200 displays the last message element, the message advancement button 230 is not displayed, or is otherwise grayed-out and non-responsive. Similarly, a previous element button 232 (shown as “Back”) permits the flight crew user to back through previously displayed HMI display screens. In one embodiment, when HMI display screen 200 displays the first message element, the previous element button 230 is not displayed, or is otherwise grayed-out and non-responsive. In one embodiment, once the flight crew user has provided or verified valid responses for each message element, a submit button 240 is displayed that will instruct CPDLC Message Processing Device 110 to compose a downlink CPDLC message from the entered responses. In one embodiment, the various buttons (222, 224, 230, 232, 240) may appear on a touch screen display and be activated by touching the screen display accordingly. Alternately, the various buttons may each be associated with a physical programmable button (shown as 251-1 to 251-12) located next to the screen 260 of the user interface device 130.

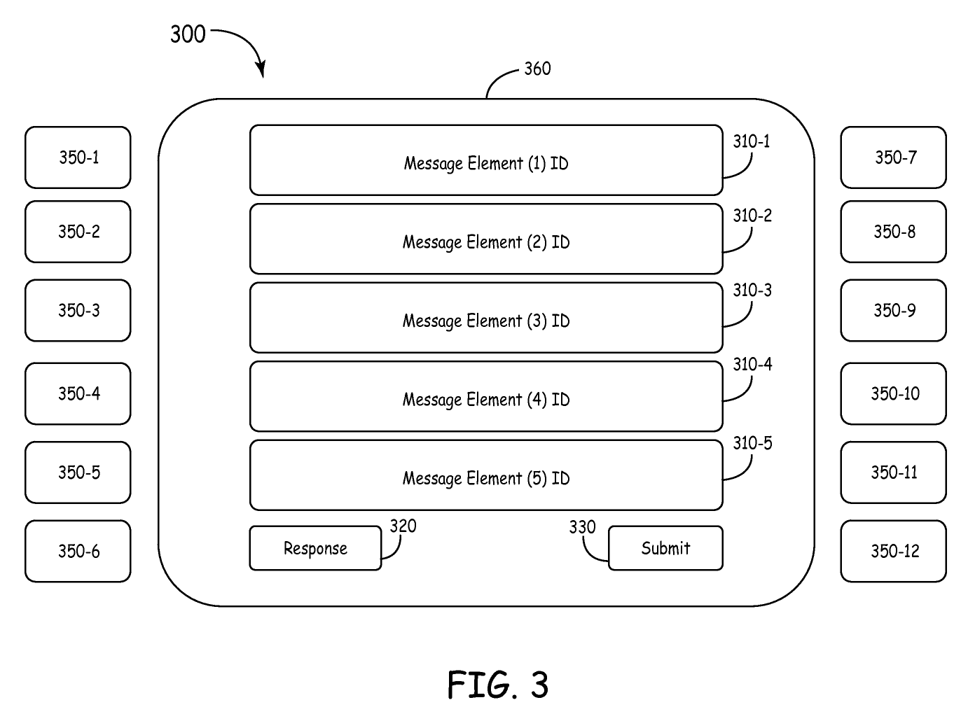

In one embodiment, illustrated by FIG. 3, CPDLC Message Processing Device 110 displays messages and prompts for valid responses through an HMI menu screen 300 that displays a listing of the different message elements. For example, when uplink 140 includes multiple message elements then an HMI menu screen such as 300 is displayed in such a way that the flight crew user can review the different message elements (shown at 310-1 to 310-5) and select individual messages elements in the order they wish. When one of the message elements 310-1 to 310-5 is selected, a separate HMI display screen (such as those shown in FIG. 2) is displayed for composing the response to the selected message element. For example, if the uplink message 140 consists of the message elements “REPORT PRESENT ALTITUDE” and “REPORT PRESENT SPEED” then when the user selects the REPORT PRESENT ALTITUDE message element, an HMI display screen for composing the response is displayed. Once the user has completed the response to that element, they are returned to the HMI menu screen 300. Then the user selects the next message element they wish respond to. Once the user has completed the response to that element, they are again returned to the HMI menu screen 300. After completing the responses for each of the message elements 310-1 to 310-5 in the uplink message, then a “Response” prompt button 320 becomes active on the display. In one embodiment, when the user selects the response prompt 320, the entire composed response message is displayed. If it's acceptable, the user submits the message (via a submit button 330, for example) to initiate sending the message. If the message is not acceptable then the user returns to appropriate message element's HMI display screen and edits the message element response. As discussed above, a CPDLC response message can be similarly provided for cases when there is a mixture of message element response types.

In one embodiment, the various user selectable touch-screen buttons may be displayed corresponding to elements 310-1 to 310-5 and buttons 320, 330. Alternately, the various buttons may each be associated with a physical programmable button (shown as 350-1 to 350-12) located next to the screen 360 of the user interface device 130.

FIG. 1B is a block diagram corresponding to FIG. 1A, illustrating CPDLC communication system 100 composing a response CPDLC message that responds to a received CPDLC message. In one embodiment, when the user enters a response for each HMI display screen 122 displayed, the CPDLC Message Processing Device 110 does not transmit individual CPDLC messages in response, but instead holds the responses in memory until responses for each message element in the incoming CPDLC message has been entered. Then, upon instruction from the user, the CPDLC Message Processing Device 110 composes an outgoing CPDLC message by assembling the entered responses as separate message elements. The message elements of the outgoing CPDLC message are placed in the same order as the corresponding incoming CPDLC message 140's message elements, regardless of the order in which the HMI display screens 122 were displayed on user interface device 130.

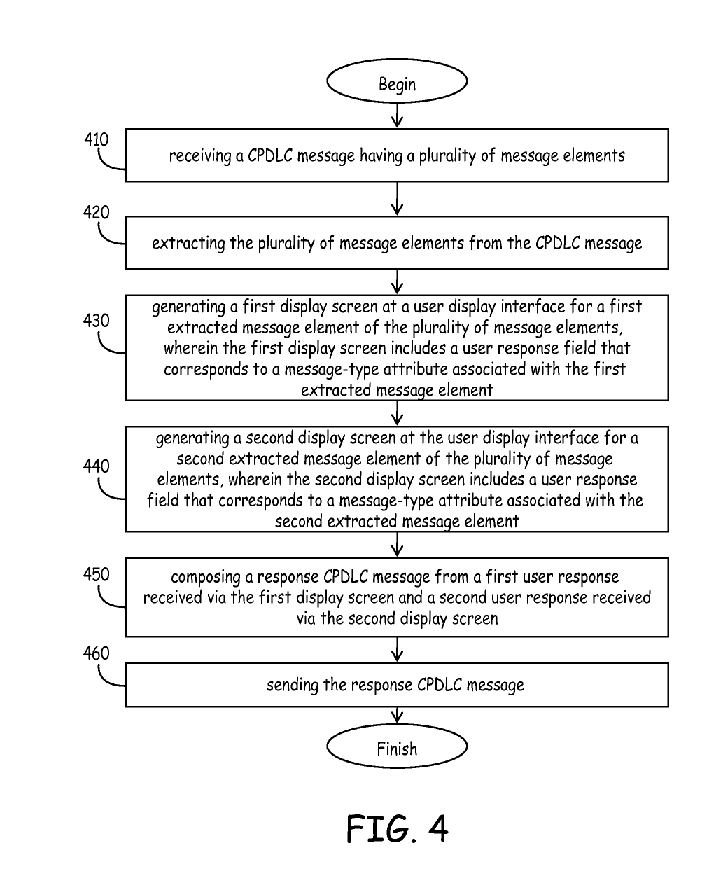

FIG. 4 is a flow chart illustrating a method for processing received CPDLC messages of one embodiment of the present invention. In one embodiment, the method of FIG. 4 is implemented at least in part through software being executed by a processor. As such, embodiments include computer executable code that when executed cause the processor and connected peripherals to perform the method illustrated, and further include physical data storage devices that store such executable code.

The method begins at 410 with receiving a CPDLC message having a plurality of message elements. In one embodiment, a received CPDLC message represents an uplink message received at an aircraft. In another embodiment, a received CPDLC message represent a downlink message received at an air traffic ground station.

The method proceeds to 420 with extracting the plurality of message elements from the CPDLC message. As discussed above, current CPDLC standard define that a CPDLC may include up to five message elements. Notwithstanding such standard, embodiments of the present invention are not so limited and may be used for processing CPDLC message having any number of message elements. Also as discussed above, each message element can include attributes such as, but not limited to, a message element ID, priority, alert level and response type. The response type defines what message elements should be used to compose the response message. CPDLC has defined the response types Wilco/Unable, Affirm/Negative, Roger, Yes and None. In one embodiment, extracting includes generating a table of extracted message elements and their respective attributes.

The method proceeds to 430 with generating a first display screen at a user display interface for a first extracted message element of the plurality of message elements, wherein the first display screen includes a user response field that corresponds to a message-type attribute associated with the first extracted message element. That is, the display screen that will be displayed at the user display interface will display the message element and a user response field appropriate for the message element. The response for a message with response type Wilco/Unable is Wilco or Unable. The response for a message with response type Affirm/Negative is Affirm or Negative. The response for a message with response type Roger is Roger or Unable. The response message element for a message with response type Yes is unique for each message element with that response type.

The method proceeds to 440 with generating a second display screen at the user display interface for a second extracted message element of the plurality of message elements, wherein the second display screen includes a user response field that corresponds to a message-type attribute associated with the second extracted message element. As such, for each message element in the received CPDLC message, a separate display screen will be provided to the user for providing a response.

In one embodiment, the first display screen defines a user selectable button that causes the user display interface to advance to the second message element. That is, it causes the second display screen to be displayed at the user display interface. Similarly, the second first display screen defines a user selectable button that causes the user display interface to go back to the previous message element. That it, it causes the first display screen to be displayed at the user display interface.

In one embodiment, the first display screen and the second display screen are displayed via the user display interface in an order based on that priority attributes associated with the first and second message elements.

In one embodiment, the method further comprises generating a menu display screen at the user display interface that lists the plurality of message elements. The menu display screen defines a first user selectable button that causes the first display screen to be displayed at the user display interface and a second user selectable button that causes the second display screen to be displayed at the user display interface.

The method proceeds to 450 with composing a response CPDLC message from a first user response received via the first display screen and a second user response received via the second display screen. That is, the user response for each received CPDLC message element defines a response element for the response CPDLC message. As such, the response message elements are arrange within the response CPDLC message such they provide the requested response for the respective corresponding message element in the received CPDLC message.

The message proceeds to 460 with sending the response CPDLC message. In one embodiment, the method further comprises generating a display screen at the user display interface that prompts the user to confirm the contents of the response CPDLC message prior to sending the response CPDLC message. In this way, the user is provided an opportunity to go back and change the provided responses.

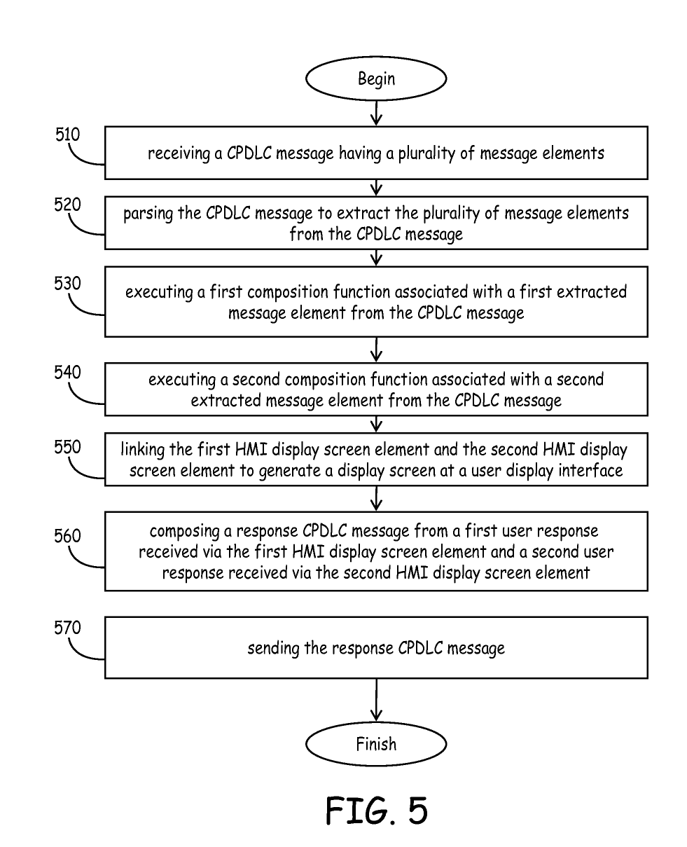

FIG. 5 is a flow chart illustrating another method for processing received CPDLC messages of one embodiment of the present invention. In one embodiment, the method of FIG. 5 is implemented at least in part through software being executed by a processor. As such, embodiments include computer executable code that when executed cause the processor and connected peripherals to perform the method illustrated, and further include physical data storage devices that store such executable code.

The method begins at 510 with receiving a CPDLC message having a plurality of message elements. In one embodiment, a received CPDLC message represents an uplink message received at an aircraft. In another embodiment, a received CPDLC message represent a downlink message received at an air traffic ground station.

The method proceeds to 520 with parsing the CPDLC message to extract the plurality of message elements from the CPDLC message. As discussed above, current CPDLC standard define that a CPDLC may include up to five message elements. Notwithstanding such standard, embodiments of the present invention are not so limited and may be used for processing CPDLC message having any number of message elements. Also as discussed above, each message element can include attributes such as, but not limited to, a message element ID, priority, alert level and response type. The response type defines what message elements should be used to compose the response message. CPDLC has defined the response types Wilco, Affirm, Roger, Yes and None. In one embodiment, extracting includes generating a table of extracted message elements and their respective attributes.

The method proceeds to 530 with executing a first composition function associated with a first extracted message element from the CPDLC message. The first composition function defines a first HMI display screen element having a user response field that corresponds to a message-type attribute associated with the first extracted message element. The method proceeds to 540 with executing a second composition function associated with a second extracted message element from the CPDLC message. The second composition function defines a second HMI display screen element having a user response field that corresponds to a message-type attribute associated with the second extracted message element.

The method proceeds to 550 with linking the first HMI display screen element and the second HMI display screen element to generate a display screen at a user display interface. As such, a single screen displayed to the user with include each of the message elements from the received CPDLC message along with response fields for each.

The method proceeds to 560 with composing a response CPDLC message from a first user response received via the first HMI display screen element and a second user response received via the second HMI display screen element. That is, the user response provided for each received CPDLC message element defines a response element for the response CPDLC message. As such, the response message elements are arranged within the response CPDLC message in the same order as the respective corresponding message elements in the received CPDLC message.

The method proceeds to 570 with sending the response CPDLC message. In one embodiment, the method further comprises generating a display screen at the user display interface that prompts the user to confirm the contents of the response CPDLC message prior to sending the response CPDLC message. In this way, the user is provided an opportunity to go back and change the provided responses.

For example, for the method of FIG. 5, instead of creating separate HMI screens the method assembles a screen containing the appropriate composition functions for the message elements in the uplink message. In one embodiment, software contains a set of predefined message element composition functions. When an uplink message is received it is parsed and the composition functions associated with the message elements in the uplink message are linked together according to the order of the message elements in the uplink in order to create a complete display screen for composing a response message. If we use the same example as above, when the uplink message contains the message elements “REPORT PRESENT ALTITUDE. REPORT PRESENT SPEED”, the software executes a function for composing the PRESENT ALTITUDE downlink message element and also executes a function for composing the PRESENT SPEED downlink message element. The software then creates a linked list of the associated functions and display the result as an HMI screen display. In this example the HMI screen display would consist of a display of the present altitude and present speed data. The user enters the data if it's not automatically filled by computer. The user may modify the data provided by the computer. When the data is acceptable, the user presses a button to initiate sending the message. If the message is not acceptable then the user returns and edits the data in the same manner as they were composed initially.

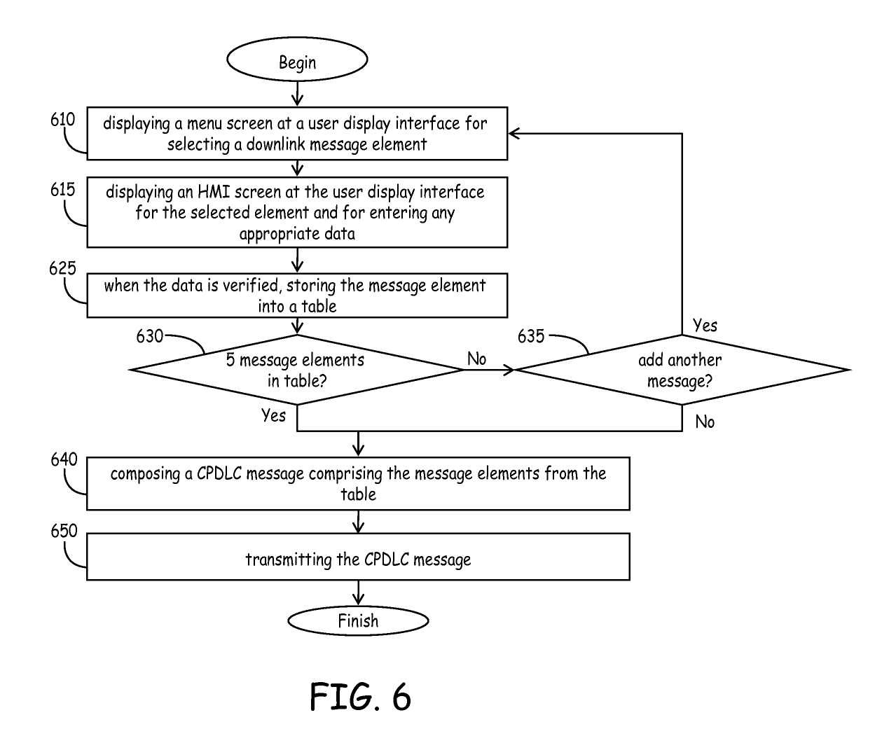

The same flexibility provided by the methods of FIGS. 4 and 5 can be achieved for composing initial messages, for Example, to allow a pilot to send an unsolicited CPDLC downlink message to the ground station. One embodiment is illustrated in FIG. 6. At 610, the method begins with the user selecting a downlink message element from a menu screen. For example, a pilot may select to send a current altitude message element and would thus select the appropriate menu item. The method proceeds to 615 with displaying an HMI screen for the selected element and for entering any appropriate data. In one embodiment, the HMI screen displayed is similar to those shown with respect to FIG. 2. In one embodiment, the data is automatically pulled up and entered by the underlying computer system and simply needs to be verified and accepted by the user. Once the data is verified, the message element is stored into a table (shown at 625), such as table 135, which identifies the message ID of the element, any data entered/verified by the user and any attributes such as discussed above. If there are less than 5 message element in the table (checked at 630), the method proceeds to 635 with prompting to determine if the user wished to add another message. If the user indicates yes, the method returns to the menu at 610. When the user indicate no, (or then there are already 5 elements in the table), the method proceeds to 640 with composing a CPDLC message comprising the message elements from the table. In one embodiment, the method further includes generating a display screen at the user display interface that prompts the user to confirm the contents of the CPDLC message prior to sending the message. When the downlink message is complete and acceptable, the method proceeds to 650 with transmitting the CPDLC message.

Several means are available to implement the systems and methods of the current invention as discussed in this specification. These means include, but are not limited to, digital computer systems, microprocessors, general purpose computers, programmable controllers and field programmable gate arrays (FPGAs) or application-specific integrated circuits (ASICs). Therefore other embodiments of the present invention are program instructions resident on computer readable media which when implemented by such means enable them to implement embodiments of the present invention. Computer readable media include any form of a physical computer memory storage device. Examples of such a physical computer memory device include, but is not limited to, punch cards, magnetic disks or tapes, optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method for processing received CPDLC messages, the method comprising:
receiving a CPDLC message having a plurality of message elements;
extracting the plurality of message elements from the CPDLC message;
generating a first display screen at a user display interface for a first extracted message element of the plurality of message elements, wherein the first display screen includes a user response field that corresponds to a message-type attribute associated with the first extracted message element;
generating a second display screen at the user display interface for a second extracted message element of the plurality of message elements, wherein the second display screen includes a user response field that corresponds to a message-type attribute associated with the second extracted message element;
composing a response CPDLC message from a first user response received via the first display screen and a second user response received via the second display screen; and
sending the response CPDLC message.

2. The method of claim 1, further comprising:
generating a menu display screen at the user display interface that lists the plurality of message elements, wherein the menu display screen defines a first user selectable button that causes the first display screen to be displayed at the user display interface; and
wherein the menu display screen defines a second user selectable button that causes the second display screen to be displayed at the user display interface.

3. The method of claim 1, wherein the first display screen defines a user selectable button that causes the second display screen to be displayed at the user display interface.

4. The method of claim 1, further comprising:
generating a display screen at the user display interface that prompts a user to confirm contents of the response CPDLC message prior to sending the response CPDLC message.

5. The method of claim 1, wherein the first user response is communicated as a first message element of the response CPDLC message and the second user response is communicated as a second message element of the CPDLC message.

6. The method of claim 1, wherein the first display screen and the second display screen are displayed on the user display interface in an order that corresponds to an order of the plurality of message elements within the CPDLC message.

7. The method of claim 1, wherein the first display screen and the second display screen are displayed on the user display interface in an order based on priority attributes associated with the first message element and the second message element.

8. The method of claim 1, further comprising:
generating a table of extracted message elements, wherein the table lists message attributes including at least one of a message identifier, priority, alert level and response type, for each message elements extracted from the CPDLC message.

9. The method of claim 1, wherein response-type attribute for the first extracted message element is one of response type Wilco/Unable, Affirm/Negative, Roger, Yes and None, and wherein the response-type attribute for the second extracted message element is one of response type Wilco/Unable, Affirm/Negative, Roger, Yes and None.

10. The method of claim 1, wherein the user display interface includes one or both of a touch screen display and a set of programmable buttons.

11. The method of claim 1, wherein composing a response CPDLC message further comprises generating a response element in the CPDLC message for each user response to message elements of the received CPDLC message.

12. A method for CPDLC communications, the method comprising:
receiving a CPDLC message having a plurality of message elements;
parsing the CPDLC message to extract the plurality of message elements from the CPDLC message;
executing a first composition function associated with a first extracted message element from the CPDLC message, wherein the first composition function defines a first HMI display screen element having a user response field that corresponds to a message-type attribute associated with the first extracted message element;
executing a second composition function associated with a second extracted message element from the CPDLC message, wherein the second composition function defines a second HMI display screen element having a user response field that corresponds to a message-type attribute associated with the second extracted message element;
linking the first HMI display screen element and the second HMI display screen element to generate a display screen at a user display interface;
compiling a response CPDLC message from a first user response received via the first HMI display screen element and a second user response received via the second HMI display screen element; and
sending the response CPDLC message.

13. The method of claim 12, wherein the first HMI display screen element and the second HMI display screen element are linked based on the order of the plurality of message elements within the CPDLC message.

14. The method of claim 12, wherein composing a response CPDLC message further comprises generating a response element in the CPDLC message for each user response to message elements of the received CPDLC message.

15. The method of claim 12, wherein the user display interface includes one or both of a touch screen display and a set of programmable buttons.

16. The method of claim 12, further comprising generating a display screen at the user display interface that prompts a user to confirm contents of the response CPDLC message prior to sending the response CPDLC message.

17. The method of claim 12, wherein response-type attribute for the first extracted message element is one of response type Wilco/Unable, Affirm/Negative, Roger, Yes and None, and wherein the response-type attribute for the second extracted message element is one of response type Wilco/Unable, Affirm/Negative, Roger, Yes and None.

18. A method for processing CPDLC messages, the method comprising:
displaying a menu screen at a user display interface for selecting a downlink message element;
displaying an HMI screen at the user display interface for a selected message element and for entering any appropriate data;
prompting user at the user display interface to verify message element and data;
when the data is verified, storing the message element into a table;
when the table includes less than five message elements, querying user to add another message element;
composing a CPDLC message comprising the message elements from the table; and
transmitting the CPDLC message

19. The method of claim 18, further comprising:
generating a display screen at the user display interface that prompts a user to confirm the contents of the CPDLC message prior to transmitting the message.

20. The method of claim 19, wherein the table lists message attributes including at least one of a message identifier, priority, alert level and response type, for each message element.
